(19) United States
(12) Patent Application Publication
(10) Pub. No.: US 2022/0005411 A1
(43) Pub. Date: Jan. 6, 2022

(54) PIXEL COMPENSATION CIRCUIT AND DISPLAY DEVICE

(71) Applicant: Everdisplay Optronics (Shanghai) Co.,Ltd., Shanghai (CN)

(72) Inventors: Huannan WANG, Shanghai (CN); Gang LIU, Shanghai (CN)

(73) Assignee: Everdisplay Optronics (Shanghai) Co.,Ltd., Shanghai (CN)

(21) Appl. No.: 17/294,021

(22) PCT Filed: Jan. 10, 2019
(86) PCT No.: PCT/CN2019/071235

§ 371 Date: May 14, 2021

(30) Foreign Application Priority Data
Nov. 16, 2018 (CN) 201811363900.7

(51) Int. Cl. G09G 3/3233

(52) U.S. Cl. CPC G09G 3/3233; G09G 2300/043; G09G 2300/0819

(57) ABSTRACT

The present disclosure provides a pixel compensation circuit and a display device including a first switching component configured to switch an electric current path between a data signal and a first node in response to a scanning signal; a third transistor configured to switch an electric current path between a second node and the first node in response to a power positive voltage signal; a fourth transistor configured to switch an electric current path between the power positive voltage signal and a third node in response to a voltage signal of the first node; a first capacitor coupled between an enable signal and the first node; a second capacitor coupled between the second node and the power positive voltage signal; and a light emitting diode having an anode coupled to the third node and a cathode coupled to a power negative voltage signal.

### CROSS-REFERENCE TO RELATED APPLICATIONS

The present application is based upon International Application No. PCT/CN2019/071235, filed on Jan. 10, 2019, which is based upon and claims priority of Chinese patent application No. 201811363900.7, filed on Nov. 16, 2018, the contents of which are hereby incorporated by reference in its entirety.

### TECHNICAL FIELD

The present disclosure relates to the field of display technologies, and more particularly, to a pixel compensation circuit and a display device.

### BACKGROUND

An active-matrix organic light emitting diode (AMOLED) is a current driving device, and when a driving current flows through the organic light-emitting diode, the organic light-emitting diode emits light. The driving current is generally supplied by an AMOLED pixel compensation circuit that generally at least includes a driving Thin Film Transistor (TFT), a switching TFT and a storage capacitor, wherein when turning on the switching TFT, a data signal is transmitted to a gate electrode of the drive TFT and stored in the storage capacitor, and a driving current is generated by the drive TFT.

### SUMMARY

The present disclosure provides a pixel compensation circuit and a display device.

According to an aspect of the present disclosure, a pixel compensation circuit is provided, including:

a first switching component configured to switch an electric current path between a data signal and a first node in response to a scanning signal;

a third transistor configured to switch an electric current path between a second node and the first node in response to a power positive voltage signal;

a fourth transistor configured to switch an electric current path between the power positive voltage signal and a third node in response to a voltage signal of the first node;

a first capacitor coupled between an enable signal and the first node;

a second capacitor coupled between the second node and the power positive voltage signal; and

a light emitting diode having an anode coupled to the third node and a cathode coupled to a power negative voltage signal.

Optionally, the first switching component includes a first transistor configured to switch the electric current path between the data signal and the first node in response to the scanning signal.

Optionally, the first transistor is a dual gate transistor.

Optionally, the first switching component includes:

a first transistor configured to switch an electric current path between the data signal and a fourth node in response to the scanning signal; and

a second transistor configured to switch an electric current path between the fourth node and the first node in response to the scanning signal.

Optionally, the first transistor, the second transistor, the third transistor, and the fourth transistor are all PMOS transistors.

Optionally, the circuit further includes a second switching component configured to switch an electric current path between an initialization signal and the third node in response to the scanning signal.

Optionally, the second switching component includes a fifth transistor configured to switch the electric current path between the initialization signal and the third node in response to the scanning signal.

Optionally, the fifth transistor is a dual gate transistor.

Optionally, the second switching component includes:

a fifth transistor configured to switch an electric current path between the third node and a fifth node in response to the scanning signal; and

a sixth transistor configured to switch an electric current path between the fifth node and the initialization signal in response to the scanning signal.

Optionally, the fifth transistor and the sixth transistor are both PMOS transistors.

An embodiment of the present disclosure further provides a display device including the above-described pixel compensation circuit.

### BRIEF DESCRIPTION OF THE DRAWINGS

In order to more clearly describe technical solutions in embodiments of the present disclosure, drawings used for the description of the embodiments or existing technologies will be briefly introduced below. Obviously, the drawings in the following descriptions are only some embodiments of the present disclosure, and those skilled in the art can also obtain other drawings based on these drawings without any creative work.

FIG. 1 is a structural schematic diagram illustrating a pixel compensation circuit according to an embodiment of the present disclosure;

FIG. 2 is a diagram of a drive waveform according to an embodiment of the present disclosure;

FIG. 3 is a schematic diagram illustrating conducting of a pixel compensation circuit at a t1 period according to an embodiment of the present disclosure;

FIG. 4 is a schematic diagram illustrating conducting of a pixel compensation circuit at a t2 period according to an embodiment of the present disclosure;

FIG. 5 is a structural schematic diagram illustrating a pixel compensation circuit according to another embodiment of the present disclosure:

FIG. 6 is a schematic diagram illustrating conducting of a pixel compensation circuit at a t1 period according to another embodiment of the present disclosure; and

FIG. 7 is a schematic diagram illustrating conducting of a pixel compensation circuit at a t1 period according to another embodiment of the present disclosure.

### DETAILED DESCRIPTION

The exemplary implementations will now be described more fully with reference to the accompanying drawings. However, the exemplary implementations may be implemented in various forms and should not be understood as being limited to the implementations set forth herein; rather, these implementations are provided so that this disclosure will be thorough and complete, and will fully convey the conception of exemplary implementations to those skilled in the art. In the drawings, the same reference numerals denote the same or similar structures, thus their repeated description will be omitted.

The features, structures or characteristics described herein can be combined in one or more embodiments in any appropriate way. In the following description, many specific details are provided for fully understanding of the embodiments of the present disclosure. However, it will be appreciated by those skilled in the art that the technical solution of the present disclosure can be implemented without one or more of the specific details, or with other methods, components, or devices, etc. In some scenarios, the known structures, materials or operations will not be illustrated or described in detail, to avoid obscuration of the aspects of the present disclosure.

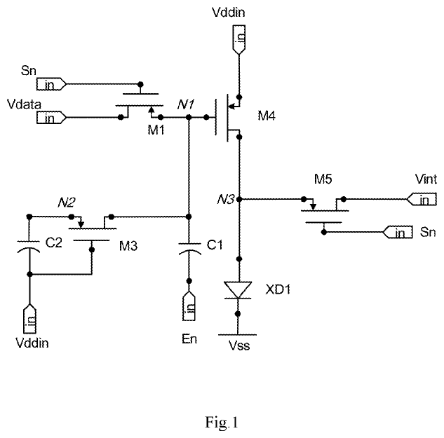

In order to solve the above-described technical problems, as shown in FIG. 1, the present disclosure provides a pixel compensation circuit including the following circuit devices:

a first switching component configured to switch an electric current path between a data signal Vdata and a first node N1 in response to a scanning signal Sn;

a third transistor M3 having a gate electrode to which a power positive voltage signal Vddin is inputted, and configured to switch an electric current path between a second node N2 and the first node N1 in response to the power positive voltage signal Vddin;

a fourth transistor M4 having a gate electrode connected to the first node N1, and configured to switch an electric current path between the power positive voltage signal Vddin and a third node N3 in response to a voltage signal of the first node N1;

a first capacitor C1 coupled between an enable signal En and the first node N1;

a second capacitor C2 coupled between the second node N2 and the power positive voltage signal Vddin; and

a light emitting diode XD1 having an anode coupled to the third node N3 and a cathode coupled to a power negative voltage signal Vss.

In this embodiment, the first switching component includes a first transistor M1, which has a gate electrode connected to the scanning signal Sn and is configured to switch the electric current path between the data signal Vdata and the first node N1 in response to the scanning signal Sn.

In this embodiment, a PMOS transistor may be used as the first transistor M1. In other implementations, other types of transistors such as an NMOS transistor may be also used as the first transistor M1. Alternatively, a dual gate transistor may be used as the first transistor M1. Compared to ordinary transistors, dual gate transistors can reduce parasitic parameters for increasement of a cutoff frequency and reducement of leakage effects.

In this embodiment, further, the third transistor M3 and the fourth transistor M4 are both PMOS transistors. In other implementations, other types of transistors, e.g., an NMOS transistor, may be also used as the third transistor M3 and the fourth transistor M4, all of which are falling within the protection scope of the present disclosure.

In this embodiment, the circuit further includes a second switching component configured to switch an electric current path between an initialization signal Vint and the third node N3 in response to the scanning signal Sn. In detail, when the second switching component is turned on, residual charges on the third node N3 can be removed, that is, residual charges on the anode of the light emitting diode XD1 can be removed. In this embodiment, the second switching component includes a fifth transistor M5, which has a gate electrode to which the scanning signal Sn is inputted, and is configured to switch the electric current path between the initialization signal Vint and the third node N3 in response to the scanning signal Sn.

Likewise, in this embodiment, the fifth transistor M5 is a PMOS transistor. In other implementations, other types of transistors such as an NMOS transistor may be also used as the fifth transistor M5, all of which are falling within the protection scope of the present disclosure. Alternatively, a dual gate transistor may be used as the fifth transistor M5, which can reduce parasitic parameters for increasement of a cutoff frequency and reducement of leakage effects.

As shown in FIG. 1, with the pixel compensation circuit in the present embodiment, the functions of a pixel compensation circuit can be implemented by using only four transistors (i.e., the first transistor M1, the third transistor M3, the fourth transistor M4, and the fifth transistor M5). Therefore, the number of transistors is reduced, and the probability of malfunction in the pixel compensation circuit or even a display device is decreased.

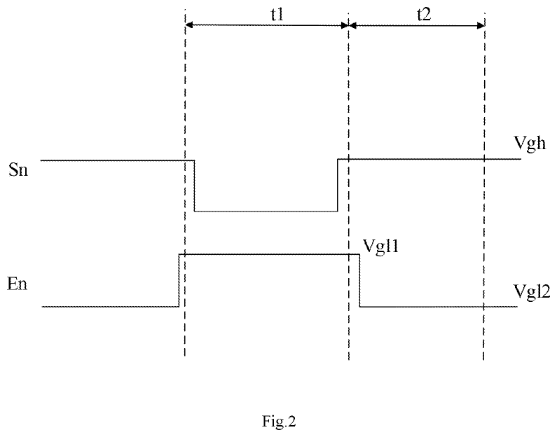

Operating principles of the pixel compensation circuit according to this embodiment will be described in detail below in conjunction with FIG. 2-FIG. 4.

As shown in FIG. 2, a driving process of a pixel is mainly performed at a t1 period and a t2 period. At the t1 period, the scanning signal Sn is at a low level, while the enable signal En is at a high level; and at the t2 period, the scanning signal Sn is at a high level with voltage of Vgh, and the enable signal En is changed from a low level to a high level with voltage changing from Vgl1 to Vgl2.

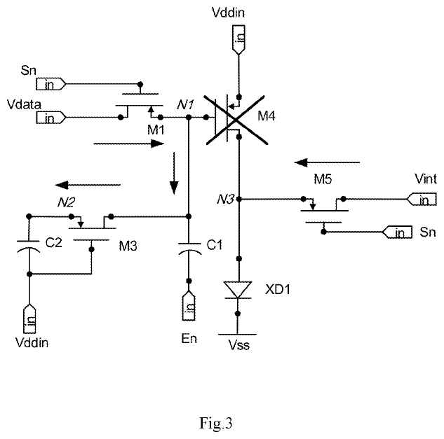

FIG. 3 is a schematic diagram illustrating conducting of a pixel compensation circuit at a t1 period according to an embodiment of the present disclosure. At this time, a scanning signal Sn is at a low level; a first transistor M1 is turned on; a data signal Vdata is written to a first node N1; a fourth transistor M4 is turned off; a fifth transistor M5 is turned on to clear residual charges on a third node N3; a third transistor M3 is turned on; and the data signal Vdata is written to a second node N2.

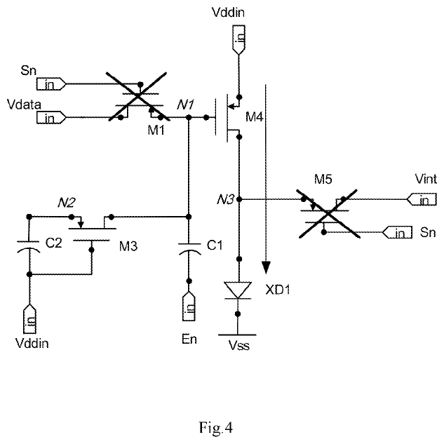

FIG. 4 is a schematic diagram illustrating conducting of a pixel compensation circuit at a t2 period according to an embodiment of the present disclosure. At this time, a scanning signal Sn is at a high level, and a first transistor M1 is turned off, and a fifth transistor M5 is turned off. An enable signal En is changed from Vgl1 to Vgl2, and a first terminal VEn of a first capacitor C1 is changed from Vgh to Vgl2 (Vgl2>Vgl1), then ΔV=Vgh−Vgl2. Voltage of the other terminal VN1 of the first capacitor C1 is decreased, i.e., VN1<VN2.

A third transistor M3 still remains in a conducting state until a voltage difference Vgs between a gate electrode and a source electrode of the third transistor M3 reaches to a cutoff voltage Vth_MT3 of the third transistor M3. At this time, the third transistor M3 is off, and the voltage of the other terminal VN1 of the first capacitor C1 becomes:

VN1=2Vdata−ΔV+Vth_MT3

At this time, a fourth transistor M4 is turned on, and electric current flowing through the fourth transistor M4 is:

Id=½μCox W/L(Vgs−Vth_MT4)2

=½μCox W/L[2Vdata−ΔV+Vth_MT3−Vth_MT4]2

where, Vth_MT4 is a cutoff voltage of the fourth transistor M4. The electric current Id is drive current for forcing a light-emitting diode XD1 to emit light.

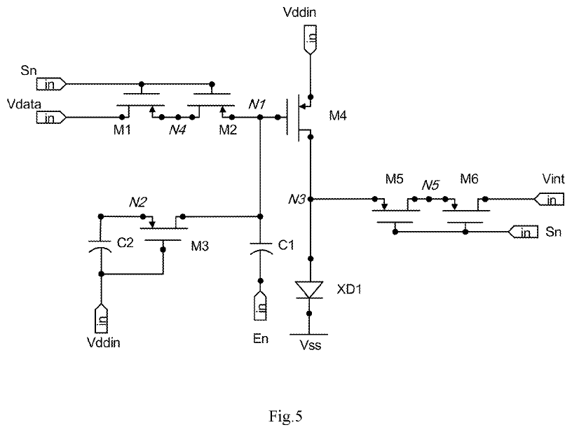

As illustrated in FIG. 5, the present disclosure also provides a pixel compensation circuit according to another embodiment. Similar to the pixel compensation circuit shown in FIG. 1, this pixel compensation circuit includes the following circuit devices:

a first switching component configured to switch an electric current path between a data signal Vdata and a first node N1 in response to a scanning signal Sn:

a third transistor M3 having a gate electrode to which a power positive voltage signal Vddin is inputted, and configured to switch an electric current path between a second node N2 and the first node N1 in response to the power positive voltage signal Vddin;

a fourth transistor M4 having a gate electrode connected to the first node N1, and configured to switch an electric current path between the power positive voltage signal Vddin and a third node N3 in response to a voltage signal of the first node N1;

a first capacitor C1 coupled between an enable signal En and the first node N1;

a second capacitor C2 coupled between the second node N2 and the power positive voltage signal Vddin; and

a light emitting diode XD1 having an anode coupled to the third node N3 and a cathode coupled to a power negative voltage signal Vss.

Unlike the pixel compensation circuit indicated in FIG. 1, in this embodiment, the first switching component includes two transistors:

a first transistor M1 having a gate electrode to which the scanning signal Sn is inputted, and configured to switch an electric current path between the data signal Vdata and a fourth node N4 in response to the scanning signal Sn;

a second transistor M2 having a gate electrode to which the scanning signal Sn is inputted, and configured to switch an electric current path between the fourth node N4 and the first node N1 in response to the scanning signal Sn.

The first transistor M1 and the second transistor M2 may form a dual gate transistor or may be two separate transistor devices.

In this embodiment, the first transistor M1, the second transistor M2, the third transistor M3, and the fourth transistor M4 are all PMOS transistors. In other implementations, other types of transistors such as an NMOS transistor may be also used as the transistors, all of which are falling within the protection scope of the present disclosure.

In this embodiment, the circuit further includes a second switching component configured to switch an electric current path between an initialization signal Vint and the third node N3 in response to the scanning signal Sn. In detail, when the second switching component is turned on, residual charges on the third node N3 can be removed, that is, residual charges on the anode of the light emitting diode XD1 can be removed.

Specifically, unlike the embodiment shown in FIG. 1, in this embodiment, the second switching component includes two transistors:

a fifth transistor M5 having a gate electrode to which the scanning signal Sn is inputted, and configured to switch an electric current path between the third node N3 and a fifth node N5 in response to the scanning signal Sn; and

a sixth transistor M6 having a gate electrode to which the scanning signal Sn is inputted, and configured to switch an electric current path between the fifth node N5 and the initialization signal Vint in response to the scanning signal Sn.

The fifth transistor M5 and the sixth transistor M6 may form a dual gate transistor or may be two separate transistor devices. In this embodiment, the fifth transistor M5 and the sixth transistor M6 may be PMOS transistors. In other implementations, other types of transistors such as an NMOS transistor may be also used as the transistors, all of which are falling within the protection scope of the present disclosure.

A drive signal waveform in this embodiment is the same as that of FIG. 2. Operating principles of the pixel compensation circuit according to this embodiment will be further described below with reference to FIGS. 2, 6, and 7.

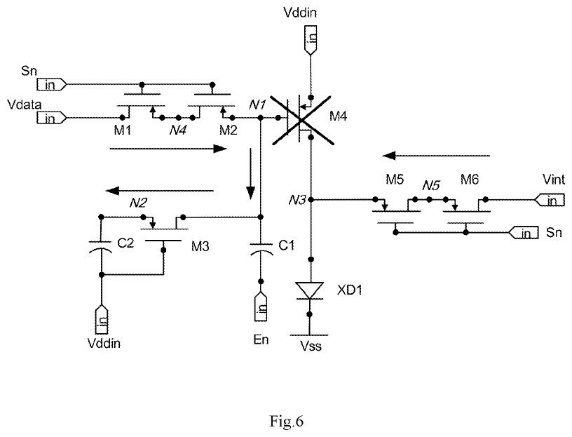

FIG. 6 is a schematic diagram illustrating conducting of a pixel compensation circuit at a t1 period according to another embodiment of the present disclosure. At this time, a scanning signal Sn is at a low level; a first transistor M1 and a second transistor M2 are turned on; a data signal Vdata is written to a first node N1; a fourth transistor M4 is turned off; a fifth transistor M5 and a sixth transistor M6 are turned on to clear residual charges on a third node N3; a third transistor M3 is turned on; and the data signal Vdata is written to a second node N2.

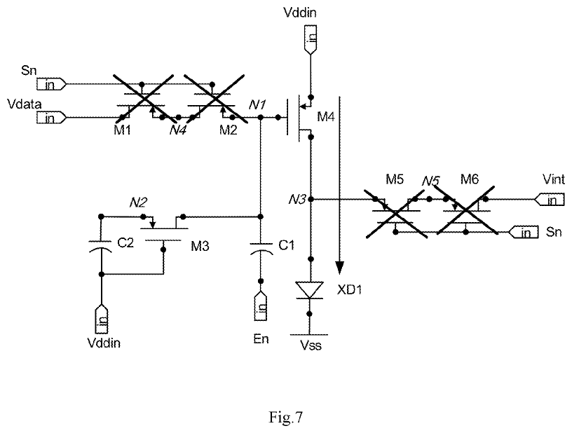

FIG. 7 is a schematic diagram illustrating conducting of a pixel compensation circuit at a t2 period according to another embodiment of the present disclosure. At this time, a scanning signal Sn is at a high level; a first transistor M1 and a second transistor M2 are turned off; and a fifth transistor M5 and a sixth transistor M6 are turned off. An enable signal En is changed from Vgl1 to Vgl2, and a first terminal VEn of a first capacitor C1 is changed from Vgh to Vgl2 (Vgl2>Vgl1), then ΔV=Vgh−Vgl2. Voltage of the other terminal VN1 of the first capacitor C1 is decreased, i.e., VN1<VN2.

A third transistor M3 still remains in a turned-on state until a voltage difference Vgs between a gate electrode and a source electrode of the third transistor M3 reaches to a cutoff voltage Vth_MT3 of the third transistor M3. At this time, the third transistor M3 is off, and the voltage of the other terminal VN1 of the first capacitor C1 becomes:

VN1=2Vdata−ΔV+Vth_MT3

At this time, a fourth transistor M4 is turned on, and electric current flowing through the fourth transistor M4 is:

Id=½μCox W/L(Vgs−Vth_MT4)2

=½μCox W/L[2Vdata−ΔV+Vth_MT3−Vth_MT4]2

where Vth_MT4 is a cutoff voltage of the fourth transistor M4. The electric current Id is drive current for forcing a light-emitting diode XD1 to emit light.

An embodiment of the present disclosure further provides a display device comprising the above-mentioned pixel compensation circuit, which uses the above-mentioned pixel compensation circuit to drive a light-emitting diode of each pixel in the display device. The pixel compensation circuit employed in the display device may be the circuit according to the embodiment shown in FIG. 1 or the circuit according to the embodiment shown in FIG. 5, and it is not limited thereto, additionally, in the pixel compensation circuit, other component parts may be added or deleted, or the second switching component may be deleted, or the first switching component may use one transistor, and the second switching component may use two transistors, or the first switching component may use two transistors, and the second switching component may use one transistor, etc., all of which are falling within the scope of protection of the present disclosure. The display device of the present disclosure can be a display device which has various sizes and functions, e.g., a mobile phone, a tablet computer, a computer display screen, a television, etc., and can be used in a wide range of applications.

By employing the pixel compensation circuit of the present disclosure, the display device of the present disclosure can further reduce the probability of malfunction due to the decrease of the number of transistors. Since a display device generally includes a plurality of pixels, in which each pixel is corresponding to a pixel compensation circuit, there will be a significant reduction in the number of the transistors for the whole display device, which not only improves the stability and service life of the display device, but also reduces the cost of production and maintenance of the display device.

The pixel compensation circuit and the display device of the present disclosure reduce the number of the transistors, lower the probability of failure occurrence of the pixel compensation circuit and of the abnormality of a display screen of the display device, and reduce the difficulty in a pixel layout of a high-resolution display device, improve display effect and service life of the display device, and decrease production and maintenance costs of the display device.

All other embodiments obtained by those skilled in the art based on the embodiments of the present disclosure without any creative efforts are falling within the scope of the present disclosure. While the preferred embodiments of the present disclosure have been illustratively shown and described, it will be understood by those skilled in the art that various changes and modifications of the present disclosure may be made without going beyond the scope defined by the claims of the present disclosure.

1. A pixel compensation circuit, comprising:
a first switching component configured to switch a first electric current path between a data signal (Vdata) and a first node (N1) in response to a scanning signal (Sn);
a third transistor (M3) configured to switch a second electric current path between a second node (N2) and the first node (N1) in response to a power positive voltage signal (Vddin);
a fourth transistor M4 configured to switch a third electric current path between the power positive voltage signal (Vddin) and a third node (N3) in response to a voltage signal of the first node (N1);
a first capacitor (C1) coupled between an enable signal (En) and the first node (N1);
a second capacitor (C2) coupled between the second node (N2) and the power positive voltage signal (Vddin); and
a light emitting diode (XD1) having an anode coupled to the third node (N3) and a cathode coupled to a power negative voltage signal (Vss).

2. The pixel compensation circuit according to claim 1, wherein the first switching component comprises a first transistor (M1) configured to switch the first electric current path between the data signal (Vdata) and the first node (N1) in response to the scanning signal (Sn).

3. The pixel compensation circuit according to claim 2, wherein the first transistor (M1) is a dual gate transistor.

4. The pixel compensation circuit according to claim 1, wherein the first switching component comprises:
a first transistor (M1) configured to switch a fourth electric current path between the data signal (Vdata) and a fourth node (N4) in response to the scanning signal (Sn); and
a second transistor (M2) configured to switch a fifth electric current path between the fourth node (N4) and the first node (N1) in response to the scanning signal (Sn).

5. The pixel compensation circuit according to claim 4, wherein the first transistor (M1), the second transistor (M2), the third transistor (M3), and the fourth transistor (M4) are all PMOS transistors.

6. The pixel compensation circuit according to claim 1, wherein the circuit further comprises a second switching component configured to switch a sixth electric current path between an initialization signal (Vint) and the third node (N3) in response to the scanning signal (Sn).

7. The pixel compensation circuit according to claim 6, wherein the second switching component comprises a fifth transistor (M5) configured to switch the sixth electric current path between the initialization signal (Vint) and the third node (N3) in response to the scanning signal (Sn).

8. The pixel compensation circuit according to claim 7, wherein the fifth transistor (M5) is a dual gate transistor.

9. The pixel compensation circuit according to claim 6, wherein the second switching component comprises:
a fifth transistor (M5) configured to switch a seventh electric current path between the third node (N3) and a fifth node (N5) in response to the scanning signal (Sn); and
a sixth transistor (M6) configured to switch an eighth electric current path between the fifth node (N5) and the initialization signal (Vint) in response to the scanning signal (Sn).

10. The pixel compensation circuit according to claim 9, wherein the fifth transistor (M5) and the sixth transistor (M6) are both PMOS transistors.

11. A display device comprising a pixel compensation circuit, wherein the pixel compensation circuit comprises:
a first switching component configured to switch a first electric current path between a data signal (Vdata) and a first node (N1) in response to a scanning signal (Sn);
a third transistor (M3) configured to switch a second electric current path between a second node N2 and the first node (N1) in response to a power positive voltage signal (Vddin);
a fourth transistor M4 configured to switch a third electric current path between the power positive voltage signal (Vddin) and a third node (N3) in response to a voltage signal of the first node (N1);
a first capacitor (C1) coupled between an enable signal (En) and the first node (N1);
a second capacitor (C2) coupled between the second node (N2) and the power positive voltage signal (Vddin); and
a light emitting diode (XD1) having an anode coupled to the third node (N3) and a cathode coupled to a power negative voltage signal (Vss).

12. The display device according to claim 11, wherein the first switching component comprises a first transistor (M1) configured to switch the first electric current path between the data signal (Vdata) and the first node (N1) in response to the scanning signal (Sn).

13. The display device according to claim 12, wherein the first transistor (M1) is a dual gate transistor.

14. The display device according to claim 11, wherein the first switching component comprises:
a first transistor (M1) configured to switch a fourth electric current path between the data signal (Vdata) and a fourth node (N4) in response to the scanning signal (Sn); and
a second transistor (M2) configured to switch a fifth electric current path between the fourth node (N4) and the first node (N1) in response to the scanning signal (Sn).

15. The display device according to claim 14, wherein the first transistor (M1), the second transistor (M2), the third transistor (M3), and the fourth transistor (M4) are all PMOS transistors.

16. The display device according to claim 11, wherein the circuit further comprises a second switching component configured to switch a sixth electric current path between an initialization signal (Vint) and the third node (N3) in response to the scanning signal (Sn).

17. The display device according to claim 16, wherein the second switching component comprises a fifth transistor (M5) configured to switch the sixth electric current path between the initialization signal (Vint) and the third node (N3) in response to the scanning signal (Sn).

18. The display device according to claim 17, wherein the fifth transistor (M5) is a dual gate transistor.

19. The display device according to claim 16, wherein the second switching component comprises:
a fifth transistor (M5) configured to switch a seventh electric current path between the third node (N3) and a fifth node (N5) in response to the scanning signal (Sn); and
a sixth transistor (M6) configured to switch an eighth electric current path between the fifth node (N5) and the initialization signal (Vint) in response to the scanning signal (Sn).

20. The display device according to claim 19, wherein the fifth transistor (M5) and the sixth transistor (M6) are both PMOS transistors.
